(19) United States
(12) Patent Application Publication
(10) Pub. No.: US 2007/0064736 A1
(43) Pub. Date: Mar. 22, 2007

(54) Zero suppressed performance management data interpretation and same value suppression and interpretation

(75) Inventors: Hari P. Miriyala, Cupertino, CA (US); Anuj Jain, San Jose, CA (US); Vasuki Gubbi, Santa Clara, CA (US)

Correspondence Address: BINGHAM MCCUTCHEN LLP, 3000 K STREET, NW, BOX IP, WASHINGTON, DC, 20007, US

(73) Assignee: Fujitsu Network Communications

(21) Appl. No.: 11/228,348

(22) Filed: Sep. 19, 2005

(51) Int. Cl. H04J 3/16

(52) U.S. Cl. 370/469

(57) ABSTRACT

Inaccurate interpretation of historical performance management data of a network element and storage of redundant performance management data of a network element is prevented. A network element is polled for current performance management data, and if the current performance management data is determined to be the same as the performance management data collected during the previous polling of the network element, the current performance management data is discarded. Otherwise, the current performance management data is stored. Differentiation between performance management data related to a “Not Available” condition and a “Zero Suppressed” condition is provided through interpretation of performance management data.

### BACKGROUND OF THE INVENTION

1. Field of the Invention

The present invention relates to a method, system, and computer program product for recovering data from a network element at a network management system (NMS), and more particularly a method, system, and computer program product for preventing the inaccurate interpretation and redundant storage of historical performance management (PM) data.

2. Description of the Related Art

As telecommunications services have proliferated, telecommunications networks have become increasingly complex. Today, telecommunications networks, using technologies such as Synchronous Optical Network (SONET), Dense Wavelength Division Multiplexing (DWDM), Asynchronous Transfer Mode (ATM), Ethernet, etc., may extend world-wide and may include thousands of network elements (NEs). Typically, such networks include network management systems (NMSs) that provide the capability to manage, provision, and maintain the thousands of network elements.

A network management system performs performance management functions that enable optimization of network service response time by managing and monitoring the behavior of the network through the collection of performance management data from the network elements on the network. Typically, the performance management data of a network element is collected by a network management system at specified intervals through autonomous reporting by the network element, polling of the network element by the network management system, or both. Network elements are polled for, or report performance management data at intervals, such as 15 minute intervals or 24 hour intervals. The collected performance management data is stored in the database of the network management system and the performance management data in the database of the network management system can be analyzed to determine the performance of the network element, such a signal degradation, aging of equipment, an other information to derive service level requirements.

Network elements can report zero or non-zero performance management data or not report any performance management data (Not Available). Non-zero performance data indicates an error condition, while zero performance data indicates normal operating conditions. “Not Available” performance management data indicates conditions, such as the performance management reporting feature is disable, there is a loss of communication with the network management system, or the network management system experienced some kind of outage. Some network elements are provided with an optimization feature that suppresses the reporting of zero performance management data when the network elements have been operating under normal conditions since the previous data collection period (Zero Suppressed). This optimization feature conserves important resources, such as the data communication channel (DCC) and data communication network (DCN). Because the performance management data to indicate “Not Available” conditions and a “Zero Suppressed” condition is the same, it is not possible to perform accurate analysis of performance management data in a network management system database from a historical perspective.

Some network elements can choose to place limitations on how performance management data is reported to a network management system or choose not to report performance management data to a network management system. Typically, the performance management data for these type of network elements do not change for long periods of time, such as years. Performance management data is obtained from these types of network elements through polling by a network management system. However, because the performance management data for these network elements do not change for long periods of time, polling these network elements for performance data at typical polling intervals will result in the storage of redundant data in network management system database over the course of time. As a result, valuable storage space in the database of a network management system is wasted.

A need arises for a technique by which inaccurate historical data interpretation and redundant data storage is prevented. In addition, a need arises for a technique by which a network element can be polled for performance management data without storing redundant performance management data. In addition, a need arises for a technique by which “Not Available” conditions and a “Zero Suppressed” condition indicated in a network management system database can be differentiated.

### SUMMARY OF THE INVENTION

The present invention prevents inaccurate historical data interpretation and redundant data storage. In addition, the present invention polls a network element for performance management data and discards performance management data that is redundant. In addition, the present invention allows differentiation between “Not Available” and “Zero Suppressed” performance management data stored in a network management system's database.

In one embodiment of the present invention, a method of performing same value suppression of performance management data from a network element at a network management system comprises the steps of determining whether a current performance management data value from the network element is the same as a previous performance management data value stored in the network management system for the network element, and if the current performance management data value is the same, discarding the current performance management data value. Otherwise, the method performs the steps of storing the current performance management data value in the network management system and associating the current performance management data value with a specific time interval.

In an aspect of the present invention, the step of determining whether a current performance management data value is the same as a previous performance management data value comprises the step of comparing the current performance management data value with the previous performance management data value.

In an aspect of the present invention, the method further comprises the step of polling the network element to obtain the current performance management data value.

In an aspect of the present invention, the method further comprises the step of interpreting performance management data stored in the network management system over a period of time.

In an aspect of the present invention, the interpretation includes identifying time intervals that legitimately do not have stored performance management data.

In one embodiment of the present invention, a system for performing same value suppression of performance management data from a network element comprises a processor operable to execute computer program instructions and a memory operable to store computer program instructions executable by the processor, for performing the steps of determining whether a current performance management data value from the network element is the same as a previous performance management data value stored in the network management system for the network element and if the current performance management data value is the same, discarding the current performance management data value. Otherwise, the system performs the steps of storing the current performance management data value in the network management system and associating the current performance management data value with a specific time interval.

In an aspect of the present invention, the step of determining whether a current performance management data value is the same as a previous performance management data value comprises the step of comparing the current performance management data value with the previous performance management data value.

In an aspect of the present invention, the system further comprises the memory operable to store computer program instructions executable by the processor, for performing the step of polling the network element to obtain the current performance management data value.

In an aspect of the present invention, the system further comprises the memory operable to store computer program instructions executable by the processor, for performing the step of interpreting performance management data stored in the network management system over a period of time.

In one embodiment of the present invention, a computer program product for performing same value suppression of performance management data from a network element comprises a computer readable medium and computer program instructions, recorded on the computer readable medium, executable by a processor, for performing the steps of determining whether a current performance management data value from the network element is the same as a previous performance management data value stored in network management system for the network element and if the current performance management data value is the same, discarding the current performance management data value. Otherwise, the computer program product performs the steps of storing the current performance management data value in the network management system and associating the current performance management data value with a specific time interval.

In an aspect of the present invention, the step of determining whether a current performance management data value is the same as a previous performance management data value further comprises the step of comparing the current performance management data value with the previous performance management data value.

In an aspect of the present invention, the computer program product further comprises computer program instructions for performing the step of polling the network element to obtain the current performance management data value.

In an aspect of the present invention, the computer program product further comprises computer program instructions for performing the step of interpreting performance management data stored in the network management system over a period of time.

In one embodiment of the present invention, a method of interpreting zero suppressed performance management data comprises logging the occurrence of events associated with not available conditions, identifying the interval that each event occurred, mapping each event to performance management of the identified interval for each event and providing performance management data to indicate that the network element was operating normally during those intervals having no performance management data and no events logged.

In one embodiment of the present invention, a system for performing same value suppression of performance management data from a network element comprises a processor operable to execute computer program instructions and a memory operable to store computer program instructions executable by the processor, for performing the steps of logging the occurrence of events associated with not available conditions, identifying the interval that each event occurred, mapping each event to performance management of the identified interval for each event and providing performance management data to indicate that the network element was operating normally during those intervals having no performance management data and no events logged.

In one embodiment of the present invention, a computer program product for performing same value suppression of performance management data from a network element comprises a computer readable medium and computer program instructions, recorded on the computer readable medium, executable by a processor, for performing the steps of logging the occurrence of events associated with not available conditions, identifying the interval that each event occurred, mapping each event to performance management of the identified interval for each event and providing performance management data to indicate that the network element was operating normally during those intervals having no performance management data and no events logged.

### BRIEF DESCRIPTION OF THE DRAWINGS

The preferred embodiments of the present invention will be described with reference to the accompanying drawings.

FIG. 1 is an exemplary block diagram of a network management system 100, in which the present invention may be implemented;

FIG. 2 is an exemplary data flow diagram of a zero suppression interpretation process according to the present invention;

FIG. 3 is an exemplary chart interpreting historical performance management data according to an embodiment of the present invention; and

FIG. 4 is an exemplary data flow diagram of a same value suppression process according to the present invention.

### DETAILED DESCRIPTION OF THE PREFERRED EMBODIMENTS

The present invention prevents inaccurate historical data interpretation and redundant data storage. In addition, the present invention polls a network element for performance management data and discards performance management data that is redundant. In addition, the present invention allows differentiation between “Not Available” and “Zero Suppressed” performance management data stored in a network management system's database.

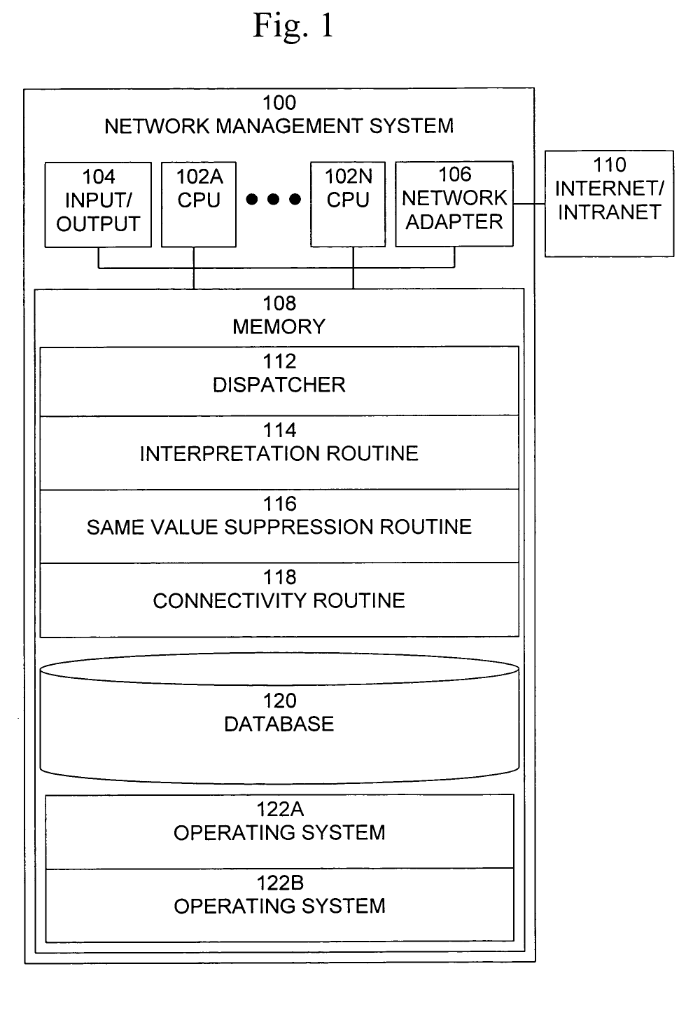

An exemplary block diagram of a network management system 100, in which the present invention may be implemented, is shown in FIG. 1. Network management system 100 is typically a programmed general-purpose computer system, such as a personal computer, workstation, client/server system, and minicomputer or mainframe computer, such as a Fujitsu NETSMART® 1500, a Fujitsu NETSMART® sp312, or a Fujitsu NETSMART® v4, but may also be a programmed special-purpose computer, custom circuitry, or the like.

Network management system 100 includes one or more processors (CPUs) 102A-102N, input/output circuitry 104, network adapter 106, and memory 108. CPUs 102A-102N execute program instructions in order to carry out the functions of the present invention. Typically, CPUs 102A-102N are one or more microprocessors, such as an INTEL PENTIUM® processor, or SPARC® RISC processor. FIG. 1 illustrates an embodiment in which network management system 100 is implemented as a single multi-processor client/server system, in which multiple processors 102A-102N share system resources, such as memory 108, input/output circuitry 104, and network adapter 106. However, the present invention also contemplates embodiments in which network management system 100 is implemented as a plurality of networked computer systems, which may be single-processor computer systems, multi-processor computer systems, or a mix thereof.

Input/output circuitry 104 provides the capability to input data to, or output data from, network management system 100. For example, input/output circuitry may include input devices, such as keyboards, mice, touchpads, trackballs, scanners, etc., output devices, such as video adapters, monitors, printers, etc., and input/output devices, such as, modems, etc. Network adapter 106 interfaces network management system 100 with Internet/intranet 110. Internet/intranet 110 may include one or more standard local area network (LAN) or wide area network (WAN), such as Ethernet, Token Ring, the Internet, or a private or proprietary LAN/WAN.

Memory 108 stores program instructions that are executed by, and data that are used and processed by, CPU 102 to perform the functions of network management system 100. Memory 108 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface. In the example shown in FIG. 1, memory 108 includes dispatcher 112, interpretation routine 114, same value suppression routine 116, connectivity routine 118, database 120, and operating systems 122A and 122B.

Dispatcher 112 monitors the amount of system resources available and using the system resources available, the weight, and the priority of operations pending, controls execution of operations in order to streamline execution of the operations. Interpretation routine 114 implements the zero suppression interpretation process for differentiating “Zero Suppressed” and “Same Value Suppressed” conditions from “Not Available” conditions indicated in network management system 100. Same value suppression routine 116 implements the process to discard performance management data reported during a current reporting interval that is the same as performance management data reported during the previous reporting interval. Connectivity routine 118 provides services that allow multiple processes running on one or more machines to interact across a network. In an embodiment of the present invention, connectivity routine 118 implement A client/server architecture, such as a Common Object Request Broker Architecture (CORBA). Operating systems 122A and 122A provide overall system functionality. In an embodiment of the present invention, operating system 122A is a server operating system, such as a Solaris® operating system. In an embodiment of the present invention, operating system 122B is a client operating system, such as a Windows® NT or a Window® 2000 operating system.

Database 120 includes a collection of information organized in such a way that network management system 100 can select and retrieve desired pieces of data. In an embodiment of the present invention, database 120 is a relational database, such as an Oracle® database. Typically, a database, such as database 120, includes not only data, but also low-level database management functions, which perform accesses to the database and store or retrieve data from the database. Such functions are often termed queries and are performed by using a database query language, such as structured query language (SQL). SQL is a standardized query language for requesting information from a database. Historically, SQL has been a popular query language for database management systems running on minicomputers and mainframes. Increasingly, however, SQL is being supported by personal computer database systems because it supports distributed databases (databases that are spread out over several computer systems). This enables several users on a local-area network to access the same database simultaneously.

As shown in FIG. 1, the present invention contemplates implementation on a client/server system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and WINDOWS®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

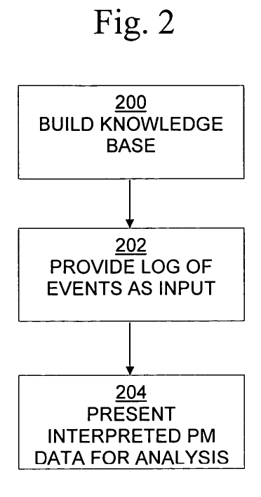

An exemplary data flow diagram of a zero suppression interpretation process according to the present invention is shown in FIG. 2. The process begins in step 200. In step 200, a knowledge base of events that impacts the collection of performance management data is built. This includes maintaining a log of events associated with “Not Available” conditions including, but not limited to, when the performance management feature of a network element is enabled, when the performance management feature of the network element is disabled, when communication between the network element and the network management system 100 is lost, when communication between the network element and the network management system 100 is restored, when the network management system 100 is down, and when network management system 100 is operational. In an embodiment of the present invention, the time that the event occurred is also logged and associated with the event.

In step 202, the log of events are provided as inputs to algorithms that identify the reasons for a “Not Available” condition. Each event logged by the network management system 100 is mapped to the performance management data reported during the time interval that each event occurred. The time intervals that have no performance management data and no events logged during the time intervals are provided with performance management data to indicate that the network element was operating normally during those intervals. The time intervals having no performance management data, but events logged during the time intervals are not modified and left with no performance management data for the intervals.

In step 204, fully interpreted historical performance management data is presented for analysis. The fully interpreted historical performance management data can be provided as a chart. The chart can indicate the time intervals where performance management data is “Zero Suppressed” and the time intervals that legitimately do not have performance management data due to the occurrence of events that prevent the reporting of performance management data.

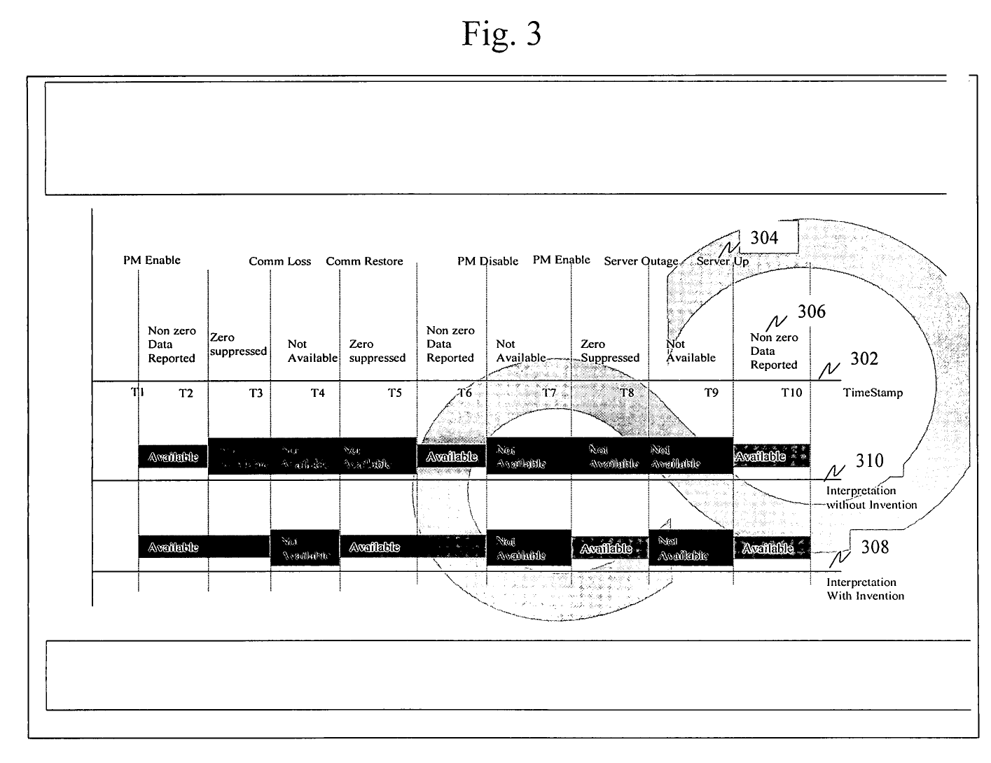

An exemplary chart interpreting historical performance management data according to an embodiment of the present invention is shown in FIG. 3. In the FIG. 3 embodiment of the present invention, chart 300 includes time stamps for logged events 302, the events logged 304, the data reported 306, un-interpreted performance management data 308, and interpreted performance management data 310. As shown by the un-interpreted performance management data 308, there is no performance management data for the time interval T2 to T3 because the performance management data was “Zero Suppressed.” However, the interpreted performance management data 310 shows performance management data for time interval T2-T3 because there was not an occurrence of a “Not Available” condition during the time interval. In contrast, the interpreted performance management data 310 shows no performance management data for time interval T3-T4 because there was a loss of communication during the interval.

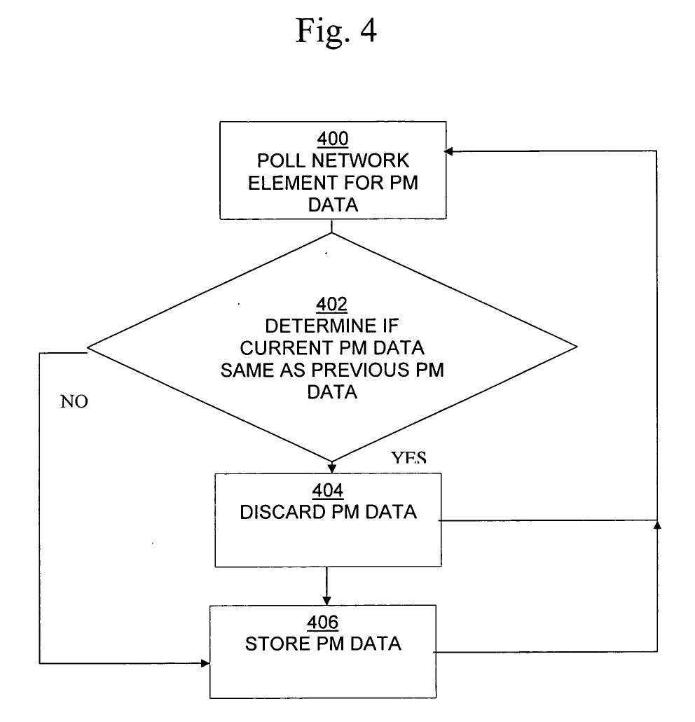

An exemplary data flow diagram of a same value suppression process according to the present invention is shown in FIG. 4. The process begins in step 400. In step 400, the network management system 100 polls a network element for performance management data. In step 402, it is determined whether the performance management data value retrieved from polling the network element is the same as the last performance management data value stored in the network management system database. If so, the process proceeds to step 404. If not, the process proceeds to step 406. In step 404, the performance management data value retrieved from polling the network element is discarded. In step 406, the performance management data value retrieved from polling the network element is stored in the network management system database and associated with a time interval. In an embodiment of the present invention, the process of FIG. 3 can be used to interpret historical performance management data stored in a network management system employing the same value suppression process of FIG. 4 to facilitate analysis.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method of performing same value suppression of performance management data from a network element at a network management system comprising the steps of:
determining whether a current performance management data value from the network element is the same as a previous performance management data value stored in network management system for the network element;
if the current performance management data value is the same, discarding the current performance management data value;
otherwise, storing the current performance management data value in the network management system and associating the current performance management data value with a specific time interval.

2. The method of claim 1, wherein the step of determining whether a current performance management data value is the same as a previous performance management data value comprises the step of comparing the current performance management data value with the previous performance management data value.

3. The method of claim 1, further comprising the network management system polling the network element to obtain the current performance management data value.

4. The method of claim 1, further comprising the step of interpreting performance management data stored in the network management system over a period of time.

5. The method of claim 4, wherein the interpretation includes identifying intervals that legitimately do not have performance management data.

6. A system for performing same value suppression of performance management data from a network element comprising:
a processor operable to execute computer program instructions; and
a memory operable to store computer program instructions executable by the processor, for performing the steps of:
determining whether a current performance management data value from the network element is the same as a previous performance management data value stored in network management system for the network element;
if the current performance management data value is the same, discarding the current performance management data value;
otherwise, storing the current performance management data value in the network management system and associating the current performance management data value with a specific time interval.

7. The system of claim 6, wherein the step of determining whether a current performance management data value is the same as a previous performance management data value comprises the step of comparing the current performance management data value with the previous performance management data value.

8. The system of claim 7, further comprising the memory operable to store computer program instructions executable by the processor, for performing the step of polling the network element to obtain the current performance management data value.

9. The system of claim 7, further comprising the memory operable to store computer program instructions executable by the processor, for performing the step of interpreting performance management data stored in the network management system over a period of time.

10. The system of claim 9, wherein the interpretation includes identifying intervals that legitimately do not have performance management data.

11. A computer program product for performing same value suppression of performance management data from a network element comprising:
a computer readable medium;
computer program instructions, recorded on the computer readable medium, executable by a processor, for performing the steps of:
determining whether a current performance management data value from the network element is the same as a previous performance management data value stored in network management system for the network element;
if the current performance management data value is the same, discarding the current performance management data value;
otherwise, storing the current performance management data value in the network management system and associating the current performance management data value with a specific time interval.

12. The computer program product of claim 11, wherein the step of determining whether a current performance management data value is the same as a previous performance management data value comprises the step of comparing the current performance management data value with the previous performance management data value.

13. The computer program product of claim 11, further comprising computer program instructions for performing the step of polling the network element to obtain the current performance management data value.

14. The computer program product of claim 11, further comprising computer program instructions for performing the step of interpreting performance management data stored in the network management system over a period of time.

15. The computer program product of claim 14, wherein the interpretation includes identifying intervals that legitimately do not have performance management data.

16. A method of interpreting zero suppressed performance management data comprising:
logging the occurrence of events associated with not available conditions;
identifying the interval that each event occurred;
mapping each event to performance management of the identified interval for each event; and
providing performance management data to indicate that the network element was operating normally during those intervals having no performance management data and no events logged.

17. A system for performing same value suppression of performance management data from a network element comprising:
a processor operable to execute computer program instructions; and
a memory operable to store computer program instructions executable by the processor, for performing the steps of:
logging the occurrence of events associated with not available conditions;
identifying the interval that each event occurred;
mapping each event to performance management of the identified interval for each event; and
providing performance management data to indicate that the network element was operating normally during those intervals having no performance management data and no events logged.

18. A computer program product for performing same value suppression of performance management data from a network element comprising:
a computer readable medium;
computer program instructions, recorded on the computer readable medium, executable by a processor, for performing the steps of:
logging the occurrence of events associated with not available conditions;
identifying the interval that each event occurred;
mapping each event to performance management of the identified interval for each event; and
providing performance management data to indicate that the network element was operating normally during those intervals having no performance management data and no events logged.
